(19) United States
(12) Patent Application Publication
(10) Pub. No.: US 2013/0111150 A1
(43) Pub. Date: May 2, 2013

(54) METHOD FOR PREVENTING DEADLOCK OF NODE CONTROLLER, AND NODE CONTROLLER

(71) Applicant: Huawei Technologies Co., Ltd., Shenzhen (CN)

(72) Inventors: Yafei Zhao, Hangzhou (CN); Ruoxing Dai, Shenzhen (CN); Xiaowei Chu, Hangzhou (CN)

(73) Assignee: Huawei Technologies Co., Ltd., Shenzhen (CN)

(21) Appl. No.: 13/708,670

(22) Filed: Dec. 7, 2012

Related U.S. Application Data
(63) Continuation of application No. PCT/CN2011/081393, filed on Oct. 27, 2011.

(51) Int. Cl. G06F 12/08

(52) U.S. Cl. CPC G06F 12/0891
USPC 711/144

(57) ABSTRACT

A method for preventing deadlock of a node controller includes receiving, by an NC of a current node, a request message from any node, and writing the request message into a processing queue; performing invalidation processing on the cache data block that includes the system address and is cached on the other node, so that the NC directly returns, upon receiving a first interception message transferred by an HA, a feedback message to the HA, thereby avoiding that the first interception message is written into the processing queue and is blocked by the request message; and the feedback message is used for indicating that the system address cached on the other node is invalid; and transferring, by the NC, to the HA, the request message written into the processing queue.

### CROSS-REFERENCE TO RELATED APPLICATIONS

This application is a continuation of International Application No. PCT/CN2011/081393, filed on Oct. 27, 2011, which is hereby incorporated by reference in its entirety.

### FIELD

The present disclosure relates to the computer field, and in particular, to a method for preventing deadlock of a node controller, and a node controller, which are applied to a non-uniform memory access (Non-Uniform Memory Access, NUMA) system.

### BACKGROUND

The structure of a conventional NUMA system is as shown in FIG. 1, where the system is constructed of three nodes: a first node N0, a second node N1, and a third node N2, and the three nodes are connected through a node network (Node Interconnect). The first node N0 includes a node controller (Node Controller, NC), a system memory (not shown in FIG. 1), a home agent (Home Agent, HA) configured to manage a system address of the system memory, a processor unit (not shown in FIG. 1), and a caching agent (Caching Agent, CA) of the processor unit. As shown in FIG. 1, the components in the first node N0 are locally interconnected (Local Interconnect), and the NC of the first node N0, the second node N1, and the third node N2 are in a node interconnection (Node Interconnect). The second node N1 and the third node N2 may be a node that only includes a processor unit and its CA, or may also be a complex node that has a structure similar to that of the first node N0.

In the NUMA system shown in FIG. 1, the HA of the first node N0 is configured to manage the system address of the system memory, and the CA of the first node N0, the second node N1, and the third node N2 may implement access to the system memory through the system address. Assume that the HA of the first node N0 manages a system address A and when the second node N1 and/or the third node N2 need to request the system address A, the second node N1 and/or the third node N2 needs to initiate a request message and transfer the request message to the NC of the first node N0, the NC of the first node N0 then transfers the request message to the HA of the first node N0, the HA of the first node N0 receives the request message and then transfers the system address A to the NC of the first node N0, and then the NC of the first node N0 transfers the system address A to the second node N1 and/or the third node N2. Further, assume that the system address A is already cached (Cached) in the second node N1 and when the CA of the first node N0 also needs to request the system address A, the CA of the first node N0 also needs to initiate a request message, and transfers the request message to the HA of the first node N0, the HA of the first node N0 receives the request message initiated by its CA and then needs to initiate an interception message, and transfers the interception message to the NC of the first node N0, and the NC of the first node N0 transfers the interception message to the second node N1. The second node N1 receives the interception message, and then transfers a feedback message to the NC of the first node N0, and then the NC of the first node N0 transfers the feedback message to the HA of the first node N0, so that the HA of the first node N0 learns that the system address A cached by the second node is valid, and further the HA of the first node N0 may transfer the system address A stored in itself to the CA of the first node N0 via a local network. Up to now, the HA of the first node N0 finishes processing of the request message initiated by the CA of the first node N0. In the foregoing procedure, the HA of the first node N0 learns that the system address A cached by the second node N1 is valid and then further transfers the system address A to the CA via the local network, so that the CA may use the system address A to access the system memory, which guarantees that the system address used by the CA of the first node N0 and the second node N1 is coherent, thereby satisfying a requirement for a cache coherence protocol (Cache Coherence Protocol) of the NUMA system.

In practice, it is found that in the NUMA system shown in FIG. 1, a queuing policy is set on the NC of the first node N0, and the request message Request from the second node N1 or the third node N2 first enters a processing queue, so that an interception message Probe initiated by the HA of the first node N0 might be blocked by the request message Request initiated by the second node N1 or the third node N2. Meanwhile, a queuing policy is also set on the HA of the first node N0, and a request message Request initiated by the CA of the first node N0 first enters a processing queue, so that a request message Request transferred by the NC of the first node N0 might also be blocked by the request message Request initiated by the CA of the first node N0. In this way, a blocking loop shown in FIG. 2 is formed between the NC and the HA of the first node N0, thereby resulting in NC deadlock of the first node N0, while the NC deadlock permanently consumes resources of the NUMA system, and eventually results in a crash of the NUMA system.

### SUMMARY

For the foregoing defects, embodiments of the present disclosure provide a method for preventing deadlock of a node controller, and a node controller, which are mainly applied to a NUMA system and are capable of preventing the deadlock of the node controller, thereby avoiding performance degradation or a crash of the NUMA system caused by the deadlock.

A method for preventing deadlock of a node controller and applied to a NUMA system includes:

receiving, by a node controller of a current node, a request message from any node, and writing the request message into a processing queue, where the request message is used for requesting a system address;

monitoring, by the node controller, whether a cache data block including the system address is cached on another node; and if yes, performing invalidation processing on the cache data block that includes the system address and is cached on the other node, so that the node controller directly returns, when receiving a first interception message transferred by a home agent of the current node, a feedback message to the home agent, so as to avoid that the first interception message is written into the processing queue and is blocked by the request message, where the first interception message is used for intercepting whether the system address is cached on the other node; and the feedback message is used for indicating that the system address cached on the other node is invalid, so that the home agent transfers the system address stored in it to a caching agent of the current node; and

transferring, by the node controller, the request message written into the processing queue to the home agent of the first node.

A node controller is applied to a NUMA system, where the node controller is located in a local node of the NUMA system, and the node controller includes:

a receiving unit, configured to receive a request message from any node, and write the request message into a processing queue, where the request message is used for requesting a system address;

a monitoring unit, configured to monitor whether a cache data block including the system address is cached on another node;

a processing unit, configured to, when a monitoring result of the monitoring unit is yes, perform invalidation processing on the cache data block that includes the system address and is cached on the other node; where

the receiving unit is further configured to receive a first interception message transferred by a home agent of the local node, where the first interception message is used for intercepting whether the system address is cached on the other node;

a transfer unit, configured to, when the receiving unit receives the first interception message, directly return a feedback message to the home agent, so as to avoid that the first interception message is written into a queue processing unit by the receiving unit and is blocked by the request message, where the feedback message is used for indicating that the system address cached on the other node is invalid, so that the home agent transfers the system address stored in it to a caching agent of the local node;

the queue processing unit, configured to store the request message written by the receiving unit, where

the transfer unit is further configured to transfer, to the home agent, the request message written into the queue processing unit.

A NUMA system includes a local node and another node other than the local node, and the local node includes a node controller, a home agent, and a caching agent, where:

The node controller receives a request message from the other node and writes the request message into a processing queue, where the request message is used for requesting a system address; the node controller monitors whether a cache data block including the system address is cached on the other node, and if yes, performs invalidation processing on the cache data block that includes the system address and is cached on the other node, so that the node controller directly returns, when receiving a first interception message transferred by the home agent, a feedback message to the home agent, so as to avoid that the first interception message is written into the processing queue and is blocked by the request message, where the first interception message is used for intercepting whether the system address is cached on the other node; and the feedback message is used for indicating that the system address cached on the other node is invalid, so that the home agent transfers the system address stored in it to the caching agent; and the node controller transfers, to the home agent, the request message written into the processing queue.

In the embodiments of the present disclosure, the node controller of the current node first monitors, after receiving the request message from any node and writing the request message into the processing queue, whether the cache data block including the system address is cached on another node. If it is found through monitoring that the cache data block including the system address is cached on the other node, the node controller performs the invalidation processing on the cache data block that includes the system address and is cached on the other node. When subsequently the node controller receives the first interception message transferred by the home agent of the current node, as the node controller has already invalidated the cache data block that includes the system address and is cached on the other node, the node controller does not need to transfer the first interception message to the other node and only needs to directly return a feedback message to the HA, so as to avoid that the first interception message is written into the processing queue by the node controller and is blocked by the request message, thereby breaking the blocking loop that the node controller and the HA depend on each other, preventing the deadlock from occurring to the node controller, and avoiding the crash of the NUMA system due to the deadlock of the node controller.

### BRIEF DESCRIPTION OF THE DRAWINGS

To illustrate the technical solutions according to the embodiments of the present disclosure more clearly, accompanying drawings used in the embodiments are introduced briefly in the following. Obviously, the accompanying drawings in the following description are merely some embodiments of the present disclosure, and persons of ordinary skill in the art may obtain other drawings from these accompanying drawings without making creative efforts.

FIG. 1 is a schematic structural diagram of a conventional NUMA system;

FIG. 2 is a schematic flow chart of deadlock occurring to an NC in a conventional NUMA system;

FIG. 3 is a schematic flow chart of a method for preventing deadlock of a node controller according to Embodiment 1 of the present disclosure;

FIG. 4 is a schematic flow chart of a method for preventing deadlock of a node controller according to Embodiment 2 of the present disclosure;

FIG. 5 is a schematic structural diagram of a node controller according to Embodiment 3 of the present disclosure;

FIG. 6 is a schematic structural diagram of another node controller according to Embodiment 3 of the present disclosure; and

FIG. 7 is a schematic structural diagram of a NUMA system according to Embodiment 4 of the present disclosure.

### DETAILED DESCRIPTION OF THE EMBODIMENTS

The technical solutions according to the embodiments of the present disclosure are clearly and completely described in the following with reference to the accompanying drawings in the embodiments of the present disclosure. Obviously, the embodiments described are only part of rather than all of the embodiments of the present disclosure. All other embodiments obtained by persons of ordinary skills in the art based on the embodiments of the present disclosure without making creative efforts shall fall within the protection scope of the present disclosure.

The embodiments of the present disclosure provide a method for preventing deadlock of a node controller, a node controller, and a NUMA system, which may prevent deadlock of a node controller, and avoids a crash of the NUMA system due to the deadlock of the node controller. The illustration is given in the following by using the specific embodiments.

### Embodiment 1

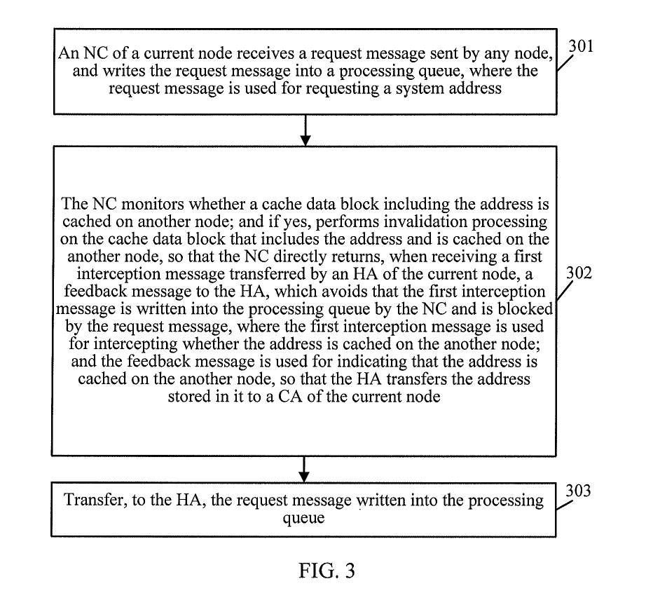

Referring to FIG. 3, FIG. 3 shows a method for preventing deadlock of a node controller according to Embodiment 1 of the present disclosure, where the method is applied to a NUMA system. As shown in FIG. 3, the method may include the following steps:

301: A node controller (NC) of a current node receives a request message from any node, and writes the request message into a processing queue, where the request message is used for requesting a system address.

In a NUMA system, a queuing policy is set on the NC, after the request message for requesting the system address is transferred to the NC, the NC needs to write the request message into the processing queue for queuing, and then performs processing according to processing permission (namely, a processing sequence).

In the NUMA system, any node may access a system memory according to the requested system address.

In the NUMA system, the current node may be a central processing unit (Central Processing Unit, CPU) or may be a symmetric multi-processing (Symmetric Multi Processing, SMP) system, which is not limited in the embodiments of the present disclosure.

302: The NC monitors whether a cache data block (Cache Line) including the system address is cached on another node; and if yes, performs invalidation processing on the cache data block which includes the system address and is cached on the other node, so that the NC directly returns, when receiving a first interception message transferred by an HA of the current node, a feedback message to the HA, avoiding that the first interception message is written into the processing queue by the NC and is blocked by the request message. The first interception message is used for intercepting whether the system address is cached on the other node; and the feedback message is used for indicating that the system address cached on the other node is invalid, so that the HA transfers the system address stored in it to a CA of the current node.

In the NUMA system, the other node may be a CPU, or may be an SMP system, which is not limited in the embodiments of the present disclosure.

As an optional implementation manner, an implementation procedure that the NC monitors whether the cache data block including the system address is cached on the other node may include the following steps:

A1. The NC transfers a second interception message SnpData to the other node, where the second interception message SnpData is used for monitoring whether the cache data block including the system address is cached on the other node.

B1. The NC receives a response message RapS transferred by the other node, where the response message RapS is used for indicating whether the cache data block including the system address is cached on the other node.

It may be seen that, through step A1 and step B1, the NC may implement the monitoring on the other node to learn whether the cache data block including the foregoing system address is cached on the other node.

As an optional implementation manner, an implementation procedure that the NC performs the invalidation processing on the cache data block that includes the system address and is cached on the other node may be:

The NC transfers an indication message SnpInvXtoI to the other node, where the indication message SnpInvXtoI is used for indicating that the other node deletes the cache data block that includes the system address and is cached in it or sets the cache data block to be unavailable.

Further, the NC may also receive an indication response message RspI transferred by the other node, and the indication response message RspI is transferred after the other node, according to the indication of the indication message SnpInvXtoI, deletes the cache data block that includes the system address and is cached in it or sets the cache data block to be unavailable.

In the NUMA system, after receiving the indication message SnpInvXtoI transferred by the NC, the other node may, according to the indication of the indication message SnpInvXtoI, delete the cache data block that includes the system address and is cached in it or set the cache data block to be unavailable. A specific implementation manner that the other node deletes the cache data block that includes the system address and is cached in it or sets the cache data block to be unavailable is common knowledge for persons skilled in the art, which is not introduced in detail here in the embodiments of the present disclosure.

The NC may learn, after receiving the indication response message RspI transferred by the other node, that the other node already performs the invalidation processing on the cache data block that includes the system address and is cached in it, so that even if receiving the first interception message transferred by the HA of the current node in the subsequent procedure, the NC does not need to transfer the first interception message to the other node, which avoids that the first interception message is written into the processing queue by the NC and is blocked by the request message.

303. The NC transfers, to the HA, the request message written into the processing queue.

In this embodiment, the NC may transfer, after monitoring that the cache data block including the system address is cached on the other node and performing the invalidation processing on the cache data block that includes the system address and is cached on the other node, according to the processing permission (that is, the processing sequence), the request message written into the processing queue to the HA of the current node, so that the HA may transfer, according to the request of the request message, the stored system address to the NC, and then the NC transfers the system address to a second node, so that the second node may adopt the system address to access the system memory.

In this embodiment, the NC may transfer, after receiving the first interception message transferred by the HA, the feedback message to the HA, so that the HA learns, according to an indication of the feedback message, that the system address cached in the other node is invalid, so that the HA may transfer, to the CA, the system address stored in it, and the CA may adopt the system address to access the system memory, thereby satisfying a requirement of a cache coherence protocol of the NUMA system.

In this embodiment, if the NC monitors that no cache data block including the system address is cached on the other node, the NC may also transfer, after receiving the first interception message transferred by the HA, the feedback message to the HA, so that the HA may transfer, to the CA, the system address stored in it, thereby finishing a handshaking process. The NC also does not need to transfer the first interception message to the other node, and may therefore avoid that the first interception message is written into the processing queue and is blocked by the request message, thereby avoiding the crash of the NUMA system due to the deadlock occurring to the NC.

In this embodiment, a sequence in which the NC transfers the request message and receives the first interception message is not limited, as long as the NC performs, before receiving the first interception message, the invalidation processing on the cache data block that includes the system address and is cached on the other node. In this embodiment, the NC already learns in advance that the other node already performs the invalidation processing on the cache data block that includes the system address and is cached in it, so that the NC does not need to transfer, upon receiving the first interception message transferred by the HA, the first interception message to the other node, thereby avoiding that the first interception message is written into the processing queue by the NC and is blocked by the request message. As the deadlock occurs because of a blocking loop of mutual dependence formed between the NC and the HA, the blocking loop causing the deadlock is broken accordingly as long as it is avoided on the NC that the first interception message is blocked by the request message, thereby further avoiding the crash of the NUMA system due to the deadlock occurring to the NC.

In this embodiment, the request message transferred by the CA is used for requesting the system address, that is to say, the request messages transferred by the CA and any node request the same system address, so that the CA and any node use the same system address, thereby satisfying the requirement of the cache coherence protocol of the NUMA system. The system address requested by the request messages transferred by the CA and any node may be any one of the multiple system addresses managed by the HA.

In the embodiment of the present disclosure, the node controller of the current node first monitors, after receiving the request message from any node and writing the request message into the processing queue, whether the cache data block including the system address is cached on another node. If it is found through monitoring that the cache data block including the system address is cached on another node, the node controller performs the invalidation processing on the cache data block that includes the system address and is cached on the other node. When subsequently the node controller receives the first interception message transferred by the home agent of the current node, as the node controller has already invalidated the cache data block that includes the system address and is cached on the other node, the node controller does not need to transfer the first interception message to the other node and only needs to directly return the feedback message to the HA, so as to avoid that the first interception message is written into the processing queue by the node controller and is blocked by the request message, thereby breaking the blocking loop in which the node controller and the HA depend on each other, preventing the deadlock from occurring to the node controller, and avoiding the crash of the NUMA system due to the deadlock occurring to the node controller.

### Embodiment 2

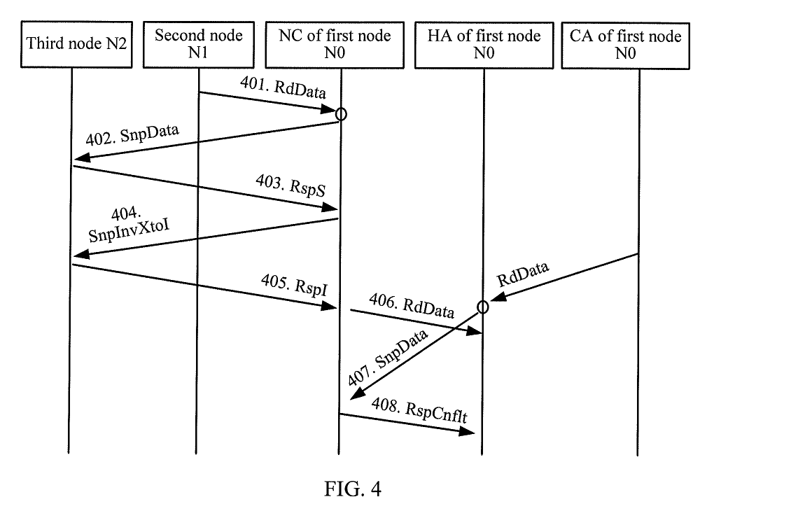

Referring to FIG. 4, FIG. 4 shows a method for preventing deadlock of a node controller according to Embodiment 2 of the present disclosure, where the method is applied to a NUMA system. In Embodiment 2, a NUMA system that satisfies a quick path interconnect (Quick Path Interconnect, QPI) protocol is taken as an example to introduce the method for preventing the deadlock of the node controller provided in the embodiment of the present disclosure. Further, in Embodiment 2, assume that a cache data block (Cache Line) including a system address A is cached in a third node N2 in the NUMA system. As shown in FIG. 4, the method may include the following steps:

401. An NC of a first node N0 receives a request message RdData for requesting a system address A, where the request message is transferred by a second node N1, and writes the request message RdData into a processing queue.

402. The NC of the first node N0 transfers an interception message SnpData to a third node N2, where the interception message SnpData is used for monitoring whether a cache data block including the system address A is cached on the third node N2.

403. The NC of the first node N0 receives a response message RapS transferred by the third node N2, where the response message RapS is used for indicating that the Cache Line including the system address A is cached on the third node N2.

404. The NC of the first node N0 transfers an indication message SnpInvXtoI to the third node N2, where the indication message SnpInvXtoI is used for indicating that the third node N2 performs invalidation processing on the Cache Line that includes the system address A and is cached in it.

405. The NC of the first node N0 receives an indication response message RspI transferred by the third node N2, where the indication response message RspI is transferred by the third node N2 after the third node N2 performs the invalidation processing, according to an indication of the indication message SnpInvXtoI, on the Cache Line that includes the system address A and is cached in it.

In this embodiment, that the third node N2 performs the invalidation processing on the Cache Line that includes the system address A and is cached in it refers to that the third node N2 deletes the Cache Line that includes the system address A and is cached in it or sets the Cache Line to be unavailable.

406. The NC of the first node N0 transfers the request message RdData, which is written into the processing queue, to the HA of the first node N0.

407. The NC of the first node N0 receives the interception message SnpData transferred by the HA of the first node N0, where the interception message SnpData transferred by the HA of the first node N0 is triggered and transferred by the HA of the first node N0 upon receiving the request message RdData for requesting the system address A, where the request message is transferred by the CA of the first node N0.

408. The NC of the first node N0 transfers immediately, upon receiving the interception message SnpData transferred by the HA of the first node N0, a feedback message RspCnfit to the HA of the first node N0.

In this embodiment, the HA of the first node N0 may write the request message RdData for requesting the system address A, where the request message is transferred by the CA, and the request message RdData transferred by the NC of the first node N0 into the processing queue for queuing and perform processing in sequence according to processing permission (namely, a processing sequence). For example, the HA of the first node N0 may transfer, according to the request message RdData transferred by the CA, the system address A to the CA; and transfer, according to the request message RdData transferred by the NC of the first node N0, the system address A to the NC of the first node N0, and then the NC of the first node N0 transfers the system address A to the second node N1.

In this embodiment, when the NC of the first node N0 receives the interception message SnpData transferred by the HA of the first node N0, the NC of the first node N0 already learns that the Cache Line with the system address A does not exist in all the nodes (that is, including the second node N1 and the third node N2) on the other side of the first node N0, therefore the NC of the first node N0 does not need to continue to transfer the interception message SnpData to the other side, and may transfer the feedback message RspCnfit to the HA of the first node N0, which avoids that the interception message SnpData is written into the processing queue by the NC of the first node N0 and is blocked by the request message RdData, thereby breaking a blocking loop of mutual dependence on the NC of the first node N0, and preventing the deadlock from occurring to the NC of the first node N0.

As an optional implementation manner, in this embodiment, in addition to the setting of the queuing policy on the NC of the first node N0, the following policy may also be set.

That is, when the NC of the first node N0 receives the request message for requesting the system address transferred by the other node, if a further request needs to be made to the HA of the first node N0 (the NC of the first node N0 cannot implement as an agent of the HA), all the Cache Lines including the system address one a side where another node locates have to be invalidated first before making a cross-domain request.

The so-called cross-domain request refers to that a request message for requesting a system address enters the HA of the first node N0 from the other node.

As shown in FIG. 4, the NC of the first node N0 finds, upon receiving the request message transferred by the second node N1, that it itself, as the HA agent, cannot satisfy the request, so that the NC of the first node N0 first invalidates, before making the cross-domain request, according to the foregoing set policy, the Cache Line with the system address A, where the Cache Line is cached on the third node N2 at the side of the second node N1. When the NC of the first node N0 receives the interception message transferred by the HA of the first node N0, although at this time the NC of the first node N0 is already processing the request message from the second node N1, the NC of the first node N0 may also transfer the feedback message to the HA of the first node for the interception message. Therefore, the HA of the first node N0 may first finish processing the request message from the CA and then continue to process the request message transferred by the NC of the first node N0.

In this embodiment, the NC of the first node N0 in the NUMA system first invalidates, upon receiving the request message transferred by the second node N1 and writing the request message into the processing queue, the Cache Line that includes the system address A and is cached on the third node N2; the NC then transfers the request message written into the processing queue to the HA of the first node N0. When the NC of the first node N0 receives the interception message transferred by the HA of the first node N0, the NC of the first node N0 has already invalidated the Cache Line that includes the system address A and is cached on the third node N2, so that the NC of the first node N0 does not need to continue to transfer the interception message to the third node N2, thereby avoiding that the interception message is written into the processing queue by the NC of the first node N0 and is blocked by the request message, breaking the blocking loop in which the NC of the first node N0 and the HA depend on each other, preventing the deadlock from occurring to the NC of the first node N0, and avoiding a crash of the NUMA system due to the deadlock occurring to the NC of the first node N0.

### Embodiment 3

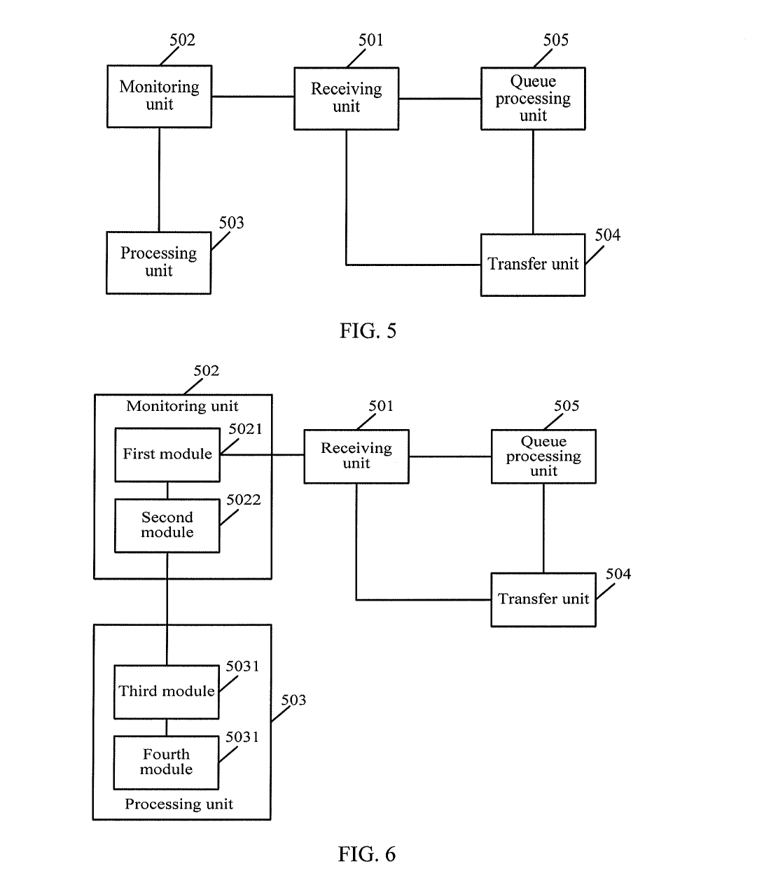

Referring to FIG. 5, FIG. 5 shows a node controller according to Embodiment 3 of the present disclosure, where the node controller is applied to a NUMA system. The node controller provided in this embodiment is located in a certain node in the NUMA system, and the node controller may include:

a receiving unit 501, configured to receive a request message from any node, and write the request message into a processing queue 505, where the request message is used for requesting a system address;

a monitoring unit 502, configured to monitor whether a cache data block including the system address is cached on another node;

a processing unit 503, configured to, when a monitoring result of the monitoring unit 502 is yes, perform invalidation processing on the cache data block that includes the system address and is cached on the other node, where

the receiving unit 501 is further configured to receive a first interception message transferred by a home agent of a current node, where the first interception message is used for intercepting whether the system address is cached on the other node;

a transfer unit 504, configured to, when the receiving unit 501 receives the first interception message, directly return a feedback message to the home agent, so as to avoid that the first interception message is written into a queue processing unit by the receiving unit 501 and is blocked by the request message, where the feedback message is used for indicating that the system address cached on the other node is invalid, so that the home agent transfers the system address stored in it to a caching agent of the current node; and

the queue processing unit 505, configured to store the request message written by the receiving unit 501, where

the transfer unit 504 is further configured to transfer, to the home agent, the request message written into the queue processing unit.

Referring to FIG. 6 together, FIG. 6 shows another node controller according to Embodiment 3 of the present disclosure, where the node controller is applied to the NUMA system. The node controller shown in FIG. 6 is obtained by optimizing the node controller shown in FIG. 5, and the node controller shown in FIG. 6 is also located in a certain node in the NUMA system. In the node controller shown in FIG. 6, the monitoring unit 502 may include:

a first module 5021, configured to transfer a second interception message to the other node, where the second interception message is used for monitoring whether the cache data block including the system address is cached on the other node; and

a second module 5022, configured to receive a response message transferred by the other node, where the response message is used for indicating whether the cache data block including the system address is cached on the other node.

Accordingly, the processing unit 503 is configured to, when the response message received by the second module 5022 indicates that the cache data block including the system address is cached on a third node, perform invalidation processing on the cache data block that includes the system address and is cached on the third node.

Further, in the node controller shown in FIG. 6, the processing unit 503 may include:

a third module 5031, configured to transfer an indication message SnpInvXtoI to the other node, where the indication message SnpInvXtoI is used for indicating that the other node deletes the cache data block that includes the system address and is cached in it or sets the cache data block to be unavailable.

Further, in the node controller shown in FIG. 6, the processing unit 503 may further include:

a fourth module 5032, configured to receive an indication response message RspI transferred by the other node, where the indication response message RspI is transferred after the other node, according to the indication of the indication message SnpInvXtoI, deletes the cache data block that includes the system address and is cached in it or sets the cache data block to be unavailable.

In this embodiment, the home agent may transfer after learning, according to an indication of the feedback message returned by the transfer unit 504, that the system address is cached on the other node, to the caching agent, the system address stored by the home agent, so that the caching agent may adopt the system address to access the network.

In this embodiment, the request message transferred by the CA of the current node is also used for requesting the system address, that is to say, the system address requested by the CA is the same as the system address requested by the request message transferred by any node, so that the CA and any node use the same system address, thereby satisfying a requirement of a cache coherence protocol of the NUMA system.

In the NUMA system, the node may be a CPU, or may be an SMP system, which is not limited in the embodiments of the present disclosure.

In the embodiment of the present disclosure, the node controller of the current node first monitors, after receiving the request message from any node and writing the request message into the processing queue, whether the cache data block including the system address is cached on the other node. If it is found through monitoring that the cache data block including the system address is cached on the other node, the node controller performs the invalidation processing on the cache data block that includes the system address and is cached on the other node. When subsequently the node controller receives the first interception message transferred by the home agent of the current node, because the node controller has already invalidated the cache data block that includes the system address and is cached on the other node, the node controller does not need to transfer the first interception message to the other node and only needs to directly return the feedback message to the HA, thereby avoiding that the first interception message is written into the processing queue by the node controller and is blocked by the request message, breaking a blocking loop in which the node controller and the HA depend on each other, preventing the deadlock from occurring to the node controller, and avoiding a crash of the NUMA system due to the deadlock occurring to the node controller.

### Embodiment 4

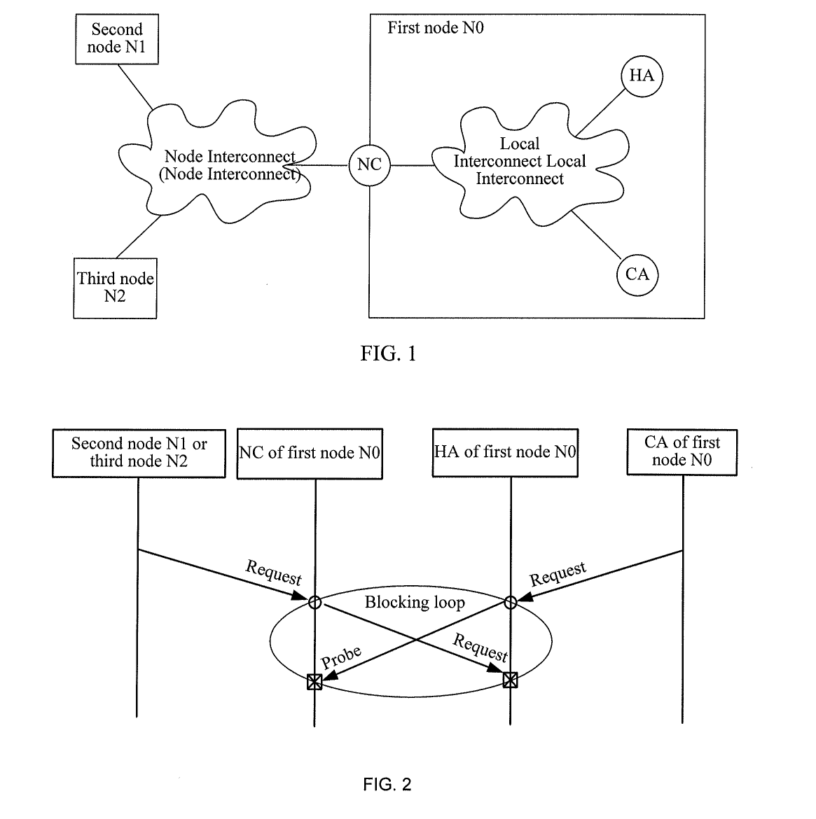

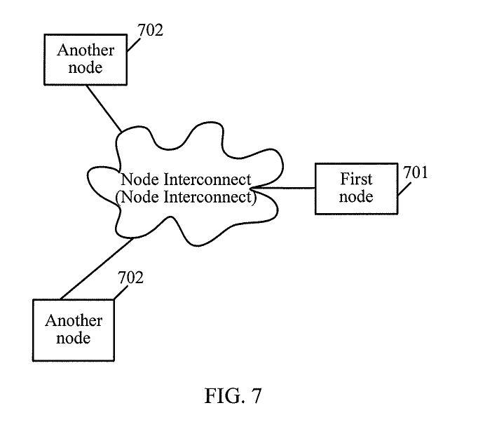

Referring to FIG. 7, FIG. 7 shows a NUMA system according to Embodiment 4 of the present disclosure. In the NUMA system shown in FIG. 7, the NUMA system includes a local node 701 and another node 702 other than the local node 701. A structure of the local node 701 is similar to the structure of the first node N0 in FIG. 1, and a difference lies in that a structure of the NC of the local node 701 is the same as the structure of the node controller shown in FIG. 5, or is the same as the structure of the node controller shown in FIG. 6.

The node controller of the local node 701 receives a request message of the other node 702 and writes the request message into a processing queue, where the request message is used for requesting a system address.

The node controller of the local node 701 monitors whether a cache data block including the system address is cached on the other node 702; and if yes, performs invalidation processing on the cache data block that includes the system address and is cached on the other node 702, so that the node controller directly returns, upon receiving a first interception message transferred by a home agent, a feedback message to the home agent, so as to avoid that the first interception message is written into a processing queue and is blocked by the request message. The first interception message is used for intercepting whether the system address is cached on the other node 702; and the feedback message is used for indicating that the system address cached on the other node 702 is invalid, so that the home agent transfers, to a caching agent, the system address stored in it, so that the node controller of the local node 701 transfers, to the home agent, the request message written into the processing queue.

The first interception message is transferred to the node controller by the home agent upon receiving the request message transferred by the caching agent, and the request message transferred by the caching agent is used for requesting the system address.

The system address requested by the caching agent is the same as the system address requested by the other node 702.

In this embodiment of the present disclosure, the node controller of the local node 701 first monitors, after receiving the request message from the other node 702 and writing the request message into the processing queue, whether the cache data block including the system address is cached on the other node 702. If it is found through monitoring that the cache data block including the system address is cached on the other node 702, the node controller performs the invalidation processing on the cache data block that includes the system address and is cached on the other node 702. When subsequently the node controller receives the first interception message transferred by the home agent, because the node controller has already invalidated the cache data block that includes the system address and is cached on the other node 702, the node controller does not needs to transfer the first interception message to the other node 702 and only needs to directly return the feedback message to the home agent, which avoids that the first interception message is written into the processing queue by the node controller and is blocked by the request message, breaks a blocking loop in which the node controller and the HA depend on each other, prevents deadlock from occurring to the node controller, and avoids a crash of the NUMA system due to the deadlock occurring to the node controller.

Persons of ordinary skill in the art may understand that, all or part of the steps of the foregoing method embodiments may be implemented by a program instructing relevant hardware. The program may be stored in a computer readable storage medium. When the program is executed, the steps of the foregoing method embodiments of the present disclosure are executed. The storage medium may be various media that may store program codes, such as a read-only memory (Read-Only Memory, ROM), a random access memory (Random Access Memory, RAM), a magnetic disk, or a compact disk, and so on.

The method for preventing deadlock of a node controller, the node controller, and the NUMA system provided in the embodiments of the present disclosure are introduced in detail in the foregoing. The principle and implementation manners of the present disclosure are described here through specific examples. The illustration about the foregoing embodiments is merely used for ease of understanding of the method and a core idea of the present disclosure. Meanwhile, persons of ordinary skill in the art may make variations in terms of the specific implementation manners and the application scope according to the idea of the present disclosure. To summarize, the specification shall not be construed as a limitation on the claims.

What is claimed is:

1. A method for processing messages in a non-uniform memory access system, comprising:
receiving, by a node controller of a first node, a request message for requesting a system address from a second node, and writing the request message from the second node into a processing queue of the node controller of the first node;
receiving, by the node controller of the first node, a first interception message from a home agent of the first node, wherein the first interception message is used for determining whether the system address is cached on another node that is in the non-uniform memory access system and is different from the first node;
returning, by the node controller of the first node, a feedback message to the home agent of the first node, wherein the feedback message indicates that the system address cached on the other node is invalid; and
transferring, by the node controller of the first node, the request message written into the processing queue of the node controller of the first node to the home agent of the first node.

2. The method according to claim 1, wherein before returning, by the node controller of the first node, the feedback message to the home agent of the first node, the method further comprises:
performing, by the node controller of the first node, invalidation processing on a cache data block of the other node, wherein the cache data block stores the system address.

3. The method according to claim 2, wherein before performing, by the node controller of the first node, invalidation processing on a cache data block of the other node that comprises the system address, the method further comprises: monitoring, by the node controller of the first node, whether the system address is cached on the cache data block of the other node; and if yes, performing the invalidation processing.

4. The method according to claim 3, wherein the monitoring, by the node controller, whether the system address is cached on the cache data block of the other node comprises:
transferring, by the node controller of the first node, to the other node, a second interception message, wherein the second interception message is used for monitoring whether the system address is cached on the cache data block of the other node; and
receiving, by the node controller of the first node, a response message transferred by the other node, wherein the response message is used for indicating that the system address is cached on the cache data block of the other node.

5. The method according to claim 2, wherein the performing, by the node controller of the first node, invalidation processing on a cache data block of the other node that comprises the system address, the method comprises:
transferring, by the node controller of the first node, an indication message SnpinvXtol to the other node, wherein the indication message SnpinvXtol indicates that the other node deletes the cache data block that comprises the system address and is cached in it or sets the cache data block to be unavailable.

6. The method according to claim 5, further comprising:
receiving, by the node controller of the first node, an indication response message RspI transferred by the other node, wherein the indication response message RspI is used to indicate that the cache data block that stores the system address has been deleted or set to be unavailable.

7. The method according to claim 1, wherein before receiving, by the node controller of the first node, a first interception message from a home agent of the first node, the method further comprises:
receiving, by the home agent of the first node, a request message for requesting the system address from a caching agent of the first node;
writing the request message from the caching agent of the first node into a processing queue of the home agent of the first node; and
sending, by the home agent of the first node, the first interception message.

8. The method according to claim 1, wherein the first node is a central processing unit or a symmetric multi processing SMP system.

9. A node controller, wherein the node controller is located in a first node of the non-uniform memory access system, and the node controller of the first node comprises:
a receiving unit configured to receive a request message for requesting a system address from a second node, write the request message from the second node into a processing queue of the node controller of the first node, and receive a first interception message from a home agent of the first node, wherein the first interception message is used for determining whether the system address is cached on another node that is in the non-uniform memory access system and different from the first node;
a transfer unit configured to return a feedback message to the home agent of the first node, wherein the feedback message indicates that the system address cached on the other node is invalid, and transfer the request message written into the processing queue of the node controller of the first node to the home agent of the first node.

10. The node controller according to claim 9, wherein the node controller further comprises:
a processing unit configured to perform invalidation processing on a cache data block of the other node, wherein the cache data block stores the system address.

11. The node controller according to claim 10, wherein the node controller further comprises:
a monitoring unit configured to determine whether the system address is cached on the cache data block of the other node, and notify the processing unit to perform the invalidation processing when the system address is cached on the cache data block of the other node.

12. The node controller according to claim 11, wherein the monitoring unit comprises: a first module configured to transfer a second interception message to the other node, wherein the second interception message is used for determining whether the system address is cached on the cache data block of the other node; and
a second module configured to receive a response message transferred by the other node, wherein the response message indicates that the system address is cached on the cache data block of the other node.

13. The node controller according to claim 11, wherein the processing unit comprises:
a third module configured to transfer, when the monitoring result of the monitoring unit is yes, an indication message SnpInvXtoI to the other node, wherein the indication message SnpInvXtoI indicates that the other node has deleted the cache data block that comprises the system address and is cached in it or sets the cache data block to be unavailable.

14. The node controller according to claim 13, wherein the processing unit further comprises:
a fourth module configured to receive an indication response message RspI transferred by the other node, wherein the indication response message RspI is transferred after the other node, according to an indication of the indication message SnpInvXtoI, deletes the cache data block that comprises the system address and is cached in it or sets the cache data block to be unavailable.

15. The node controller according to claim 9, wherein the first interception message is transferred to the node controller by the home agent upon receiving the request message transferred by a caching agent of the local node, and the request message transferred by the caching agent is used for requesting the system address.

16. The node controller according to claim 9, wherein the local node is a central processing unit or a symmetric multi processing SMP system.

17. A non-uniform memory access system, comprising a first node and a node other than the first node, wherein the first node comprises a node controller, a home agent, and a caching agent, wherein:
the node controller receives a request message for requesting a system address from a second node, writes the request message from the second node into a processing queue of the node controller of the first node, receives a first interception message from a home agent of the first node, wherein the first interception message is used for determining whether the system address is cached on the other node that is in the non-uniform memory access system and that is different from the first node, returns a feedback message to the home agent of the first node, wherein the feedback message indicates that the system address cached on the other node is invalid, and transfers the request message written into the processing queue of the node controller of the first node to the home agent of the first node.

18. The non-uniform memory access system according to claim 17, wherein the first interception message is transferred to the node controller by the home agent upon receiving the request message transferred by the caching agent, and the request message transferred by the caching agent is used for requesting the system address.
